(19) United States
(12) Patent Application Publication
(10) Pub. No.: US 2023/0046987 A1
(43) Pub. Date: Feb. 16, 2023

(54) User Attachment for Gait and Balance Rehabilitation Apparatus

(71) Applicant: Hocoma AG, Volketswil (CH)

(72) Inventors: Adrian Moser, Zurich (CH); Jan Frederik Veneman, Fallanden (CH)

(21) Appl. No.: 17/788,116

(22) PCT Filed: Dec. 23, 2020
(86) PCT No.: PCT/EP2020/087780

§ 371 Date: Jun. 22, 2022

(30) Foreign Application Priority Data
Dec. 23, 2019 (EP) 19219380.3

(51) Int. Cl. A61H 1/02; A61H 1/00; A61H 3/00

(52) U.S. Cl. CPC A61H 1/0237; A61H 1/001; A61H 3/008; A61H 2201/1652; A61H 2201/5061

(57) ABSTRACT

A user attachment for an apparatus for gait rehabilitation providing a possibility for a user to receive support during walking in a walking direction. A harness is attached to the body of the user and can be connected to a weight supporting device. This connection is a driven attachment arm attached at the weight supporting device which can be detachably connected with the harness. The driven attachment arm is connected via a double parallelogram unit with the harness attachment element. A guiding attachment arm can be connected with the weight supporting device and can be detachably connected with the harness attachment element for a rotative connection of the driven attachment arm with the guiding attachment arm.

### CROSS-REFERENCE TO RELATED APPLICATIONS

This application is the United States national phase of International Application No. PCT/EP2020/087780 filed Dec. 23, 2020, and claims priority to European Patent Application No. 19219380.3 filed Dec. 23, 2019, the disclosures of which are hereby incorporated by reference in their entirety.

### BACKGROUND OF THE INVENTION

### Field of the Invention

The present invention relates to a user attachment for gait and balance rehabilitation apparatus.

### Description of Related Art

WO 2014/202767 from the applicant discloses an apparatus for gait rehabilitation with a pelvis attachment fixed at the apparatus from behind and cuffs for the attachment of legs fixed at driven guide legs provided at the exterior of each leg of the user of the apparatus.

A gait rehabilitation apparatus using guide legs provided behind the legs of the user is disclosed in US 2015/0328078 A1. The guide leg is connected with cuffs at the legs via four attachment members provided at the guide hip joint, the guide knee joint, the guide ankle joint and the guide bottom foot.

EP 2 881 008 A1 relates to a walking training apparatus with a harness for the upper body and a seat for the user extending in front between the legs as a bicycle riding saddle. The legs of the user are connected via cuffs to a leg actuation mechanism comprising a three-dimensional parallelogram construction.

EP 1 728 492 A1 discloses an apparatus for limb assisting includes a body attachment, a link for an upper leg, and a knee joint unit, a link for a lower leg, a lower limb attachment, a drive unit and a knee joint actuator. The body attachment is attached to a trunk of a user. The link for an upper leg is placed alongside an upper leg of the user and coupled with the body attachment. The link for a lower leg is placed alongside a lower leg of the user and coupled with the link for the upper leg via the knee joint unit. The lower limb attachment is attached to one of the lower leg and a foot of the user, and coupled with the link for a lower leg. The knee joint actuator is placed in the body attachment so as to apply rotational torque to the knee joint unit via the drive unit.

U.S. Pat. No. 8,608,674 B2 discloses a pelvis interface including a subject attachment module with a waist attachment and a back attachment. The interface further includes an arm assembly coupled to the subject attachment module, the arm assembly including a plurality of arms so coupled to one another and/or to the subject attachment module as to permit the subject attachment module at least one pelvis translation degree of freedom and at least one pelvis rotation degree of freedom. The interface further include motors so coupled to the arm assembly as to actuate at least one pelvis translation degree of freedom and at least one pelvis rotation degree of freedom.

CN 105 726 266 A discloses a swinging joint device with a driving shaft member, a first swinging arm that is swingably supported about the driving shaft member; a driven shaft member that is arranged parallel to the driving shaft member; an interlocking swinging member that swings about the driven shaft member in an interlocking manner with swinging of the first swinging arm; an elastic body that is connected to the interlocking swinging member to generate an urging force in a direction opposite to an interlocking swinging direction of the interlocking swinging member; a rigidity variable portion that varies rigidity of the elastic body seen from the interlocking swinging member; a first angle detection portion that detects a swinging angle; and a control portion that controls the rigidity variable portion according to the swinging angle detected by the first angle detection portion to adjust the rigidity of the elastic body seen from the interlocking swinging member.

### SUMMARY OF THE INVENTION

In order to use any gait rehabilitation apparatus, it is necessary to put the user in the position shown in the drawings of the prior art devices. Usually, the user is sitting in a wheelchair and the different gait rehabilitation apparatuses, especially when connected with a treadmill unit do not provide so much space for a convenient “loading” of the user into the gait rehabilitation apparatus. This is true, even if the user can stand for application of the gait rehabilitation apparatus. When the user is suspended from above, it is possible to equip the user with the harness and attach the harness with the cable of the lifting device. However, this approach is not possible for devices which have a pelvis attachment from behind.

It is an object of the present invention to provide an improvement of an attachment of a user independent from the application for gait and/or for balance rehabilitation.

A user attachment for an apparatus for gait and balance rehabilitation is disclosed providing a possibility for a user to receive support during walking in a walking direction. A harness is attachable to the body of the user. Upper body attachment is usually understood to be at the trunk or at the pelvis. A driven attachment arm is configured to be attached at a weight supporting device and these elements can be detachably connected with the harness having a harness attachment element. The driven attachment arm is connected via a linkage assembly, which comprises a linkage attachment arm, with the harness attachment element. A guiding attachment arm is configured to be attached at the weight supporting device and is rotatably connected with the harness attachment element or the linkage attachment arm for a rotative connection of the driven attachment arm with the guiding attachment arm.

The driven attachment arm can comprise a support arm and a linkage arm, wherein the support arm is rotatably attached on a first rotation axis at the weight supporting device at one end and provides a second rotation axis at its other end, wherein the linkage arm is rotatably connected at the second rotation axis with the support arm at one end and provides a third rotation axis at its other end, wherein the harness attachment element is rotatably connected at the third rotation axis.

The guiding attachment arm can comprise a support arm and a linkage guiding arm, wherein the support arm is rotatably attached on a fourth rotation axis at the weight supporting device at one end and provides a fifth rotation axis at its other end, wherein the linkage guiding arm is rotatably connected at the fifth rotation axis with the support arm at one end and provides a rotatable connection at its other end being connected with the harness attachment element or with the linkage attachment arm for said rotative connection of the driven attachment arm with the guiding attachment arm.

Within this last mentioned user attachment, none, one or at least two of the first, second, fourth and fifth rotation axis can be chosen to be driven axes.

The above mentioned fourth rotation axis is preferably parallel to the first rotation axis and wherein these two axes are essentially vertical one to the other.

It is also possible that the first rotation axis of the driven attachment arm as well as the fourth rotation axis of the guiding attachment arm are concentric one to the other, which is shown in FIG. 8.

In a preferred embodiment, the driven attachment arm comprises a force transmitting parallelogram mechanism wherein the force transmitting parallelogram mechanism is connected between the first rotation axis and the harness attachment element for orienting the harness attachment element and an attached harness.

The force transmitting parallelogram mechanism can have a parallelogram arm connected at the first rotation axis, wherein said parallelogram arm is fixed, passively rotating or actively driven.

The first rotation axis and/or the fourth rotation axis can comprise torque sensors to control the rotation with a horizontal force measurement. Such a configuration allows to control the planar forces on the body, which facilitates interactive support to the balance of the person during walking.

An apparatus for gait and balance rehabilitation comprises a main frame providing a possibility for a user to receive support during walking in a walking direction within this main frame and further comprises a weight supporting device and a user attachment as described above.

The weight supporting device in such an apparatus can be divided into a first weight supporting unit and a second weight supporting unit, wherein the driven attachment arm is attached at the first supporting unit and the guiding attachment arm is attached at the second weight supporting unit. Then the driven attachment arm is attached at the first weight supporting unit and the guiding attachment arm is attached at the second weight supporting unit, respectively, in a distance one from the other in a transverse direction in view of the intended walking direction of a user.

Preferably, for this last mentioned device, the connection between the guiding attachment arm and the driven attachment arm at either the harness attachment element or the linkage attachment arm is detachable. It is an advantage when the connection comprises a reception for a pin, which pin is oriented orthogonally in view of the linkage arms and thus parallel to each of the pivoting axes of the two linkage arms. The reception comprises closable jaws configured to be opened to allow introduction and accommodating the pin in the reception by simple relative pivoting movement between the two linkage arms and subsequent closure of the jaws securing the closed bearing for a movement of the axis of the pin in the plan through pivoting movement of the linkage arms.

The user attachment as mentioned above has the advantage that it provides a simple and convenient way to attach the user to any gait training device, especially having a treadmill and leg cuffs, usually provided already in position above the treadmill. Then a method comprises the steps of:
pivoting the driven attachment arm and the guiding attachment arm to one side or to two opposing sides towards one or two parking positions in view of the walking direction into vicinity of the side weight supporting device(s),
moving the user from behind the one or two side weight supporting device(s) in view of the walking direction until the user is with his back in front of the harness attachment element,
pivoting the driven attachment arm and the guiding attachment arm from the parking positions in a use position for attaching the harness attachment element with the harness of the user.

Said last mentioned step is followed, when the parking positions are separated on two sides, by a closing step connecting the driven attachment arm and the guiding attachment arm at a rotative connection point at the free ends of both the driven attachment arm and the guiding attachment arm, efficiently providing a two-sided support of the user.

Further embodiments of the invention are laid down in the dependent claims.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1 shows a schematical top view of a user attachment for a gait rehabilitation apparatus behind a user;

FIG. 2 shows a schematical top view of the gait rehabilitation apparatus of FIG. 1 when the user is attached in the middle of the device;

FIG. 3 shows the schematical top view of FIG. 2 when the user is moving forward and to the side to his or her walking direction;

FIG. 4 shows a schematical top view of a further user attachment for a gait rehabilitation apparatus behind a user in a centered position;

FIG. 5 shows a schematical top view of the gait rehabilitation apparatus of FIG. 4 when the user is in a forward left position in relation to the device;

FIG. 6 shows a schematical top view of the gait rehabilitation apparatus of FIG. 4 when the user is in a backward right position in relation to the device;

FIG. 7 shows a schematical top view of the gait rehabilitation apparatus of FIG. 4 when the user is in a left and rotated to the right position in relation to the device;

FIG. 8 shows a schematical top view of a further user attachment for a gait rehabilitation apparatus behind a user in a centered position; and

FIG. 9 shows a detail view of an embodiment of connection between the linkage arms for a gait rehabilitation apparatus of FIG. 1.

### DESCRIPTION OF THE INVENTION

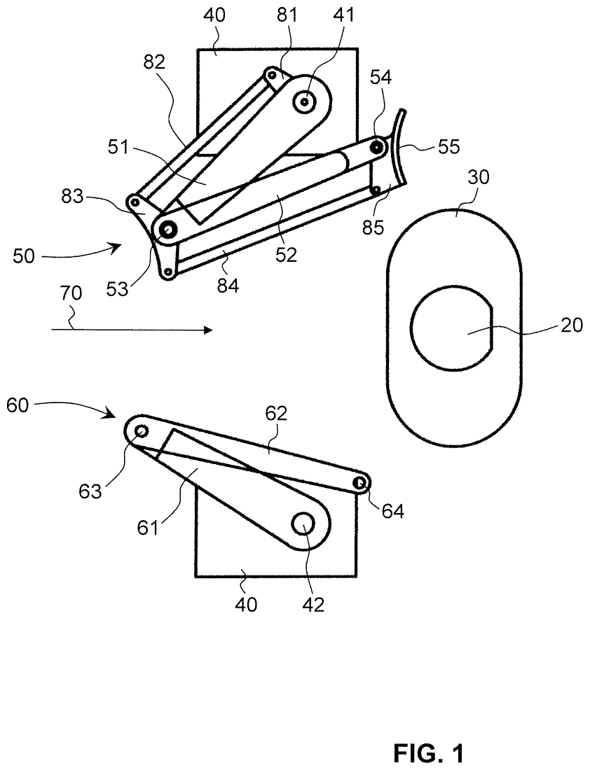

FIG. 1 shows a schematical side view of a user attachment for a gait rehabilitation apparatus behind a user 20. Such an apparatus for gait rehabilitation comprises a main frame providing a possibility for a user 20 to receive support during walking in a walking direction 70 within this main frame.

A harness 30 is attached to the upper body of the user 20. This can be done while the user 20 is standing or when the user 20 is sitting in a wheelchair.

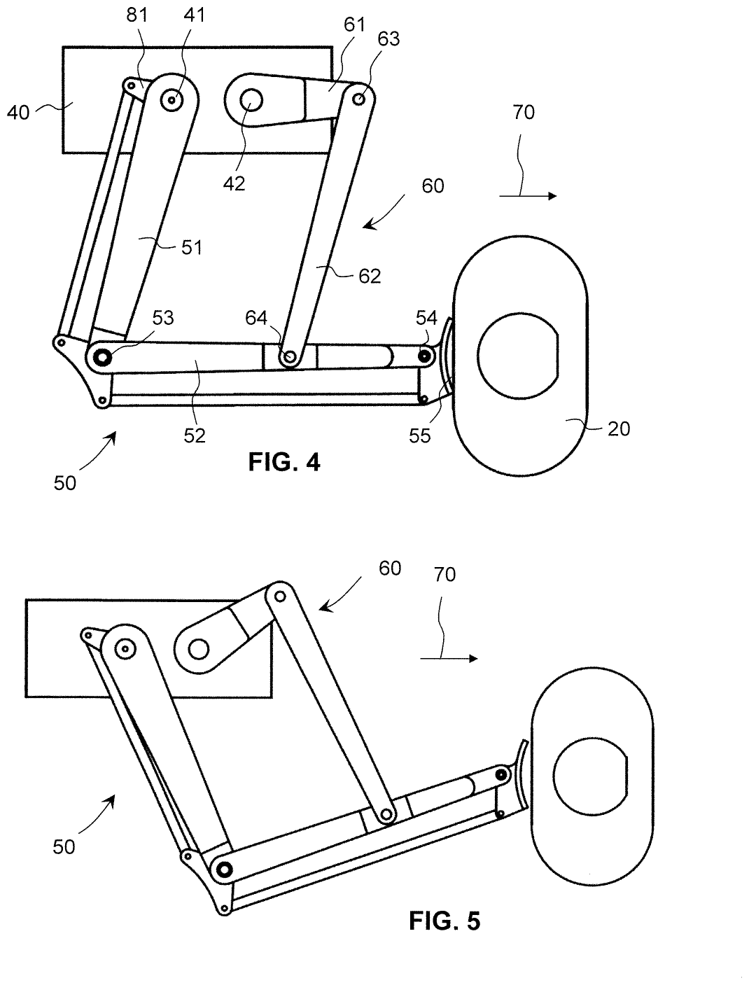

A weight supporting device 40 is shown having two side parts, one side part on each side of the user 20 usually comprising a vertical post at which is connected a driven attachment arm 50. The driven attachment arm 50 can be detachably connected with the harness 30. In other embodiments as shown in FIGS. 4 to 7, all parts of the weight support device 40 may be placed behind the user while in other embodiments all parts may be placed on one side, which provides more access to the user for a third person helping the user.

When the user moves, he or she moves with the support, partial support or even without the support of the driven attachment arm 50 and further elements of the weight supporting device 40. The amount of support can be adjusted to the abilities and needs of the user. This of course also applies for the embodiment according to FIGS. 4 to 7.

The driven attachment arm 50 comprises a support arm 51, a linkage arm 52, a force transmitting parallelogram mechanism 81, 82, 83, 84 as well as 85, and a harness attachment element 55. The support arm 51 is rotatably attached on a first rotation axis 41 at the weight supporting device 40 at one end and provides a second rotation axis 53 at its other end. The linkage arm 52 is rotatably connected at the second rotation axis 53 with the support arm 51 at one end and provides a third rotation axis 54 at its other end. Finally, the harness attachment element 55 is rotatably connected at the third rotation axis 54.

The force transmitting parallelogram mechanism comprises a distal connector 81 rotatably connected at the first rotation axis 41, a first parallelogram rod 82 rotatably connected with other end of the connector 81 and a two-armed lever 83 rotatably connected at the other end of the first parallelogram rod 82. The two-armed lever 83 is rotatably connected with the support arm 51 and transmits the driven rotative movement of the connector 81 via the rotative joint between support arm 51 and linkage arm 52 onto the second parallelogram rod 84 which transmits the movement via the proximal connector 85 onto the harness attachment element 55. The proximal connector 85 is rotatably connected with the linkage arm 52 at the third rotation axis 54 and rotatably connected at the end of the second parallelogram rod 84.

A driven rotation of the distal connector 81 around the first rotation axis 41 rotates and drives the harness attachment element 55 for orienting the harness attachment element 55 and an attached harness 30.

Preferably, a first drive is provided rotating the support arm 51 around first rotation axis 41. A second drive is rotating support arm 61 around the fourth rotation axis 42. A third drive is rotating the distal connector 81 around the first vertical axis 41. The other axes with reference numerals 53, 54, 63, 64, as well as the connecting joints between 81-82, 82-83, 83-84, 84-85 can rotate freely.

It is the third drive providing the rotation of the harness attachment element 55 around the vertical axis via the parallelogram 81-85.

When the connection 64 is closed between the units 50 and 60, the first and the second drives synergistically move the location of the harness attachment element 55 in the horizontal plane. In a symbolic way, if the first and second drives are working in the same direction, the harness attachment element 55 is moved in movement direction, if they are turning in opposite direction, the movement is transversal.

Additional drives can be contained in the weight support units 40, e.g. one drive for changing the unloading force and a further drive for lifting the mechanism as such.

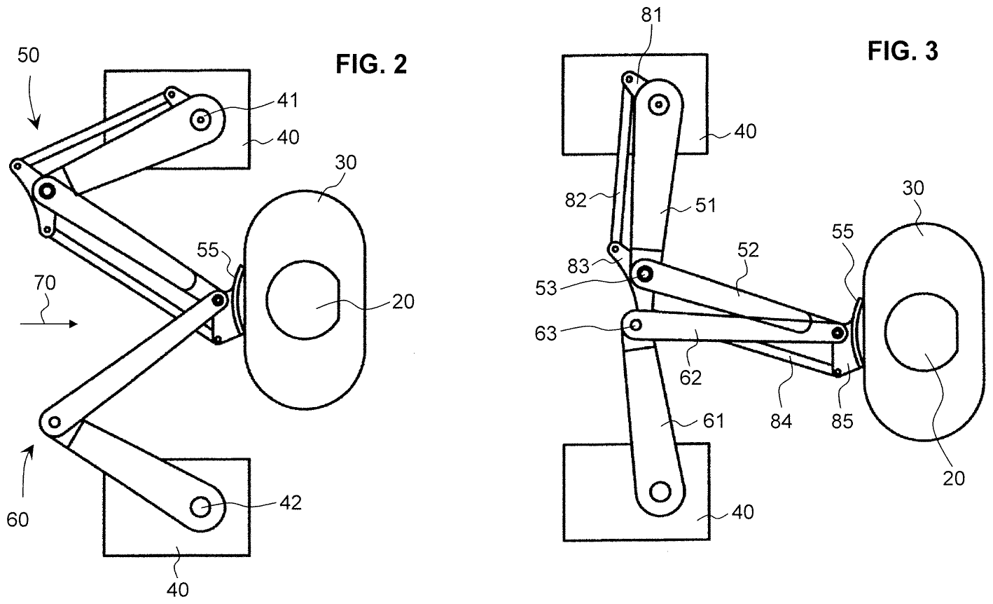

FIG. 2 shows a schematical top view of the gait rehabilitation apparatus of FIG. 1 when the user 20 is attached in the middle of the device; and FIG. 3 shows the schematical top view of FIG. 2 when the user 20 is moving sideways to his walking direction 70.

The fourth rotation axis 42 is parallel to the first rotation axis 41 and the two axes 41, 42 are essentially vertical in a distance allowing the user to enter between two parts of the weight supporting device 40. The two axes 41, 42 are provided in a distance one from the other in a transverse direction in view of the intended walking direction 70 of a user 20 that the user 20 can pass from behind in the walking direction 70 between the driven attachment arm 50 and the guiding attachment arm 60.

While all axes 41,42,53,54,63,64, as well as the connecting joints between 81-82, 82-83, 83-84, 84-85 are preferably vertical, some embodiments may have some or all of them inclined compared to the vertical, e.g. to compensate for a user leaning forward during walking, e.g. by 10°. The inclination can also be chosen only to divert a little bit from the vertical to allow some deviation from the vertical direction.

For embodiments in which a driven rotation of the harness attachment element is not desired, the third drive at rotation axis 54 can be replaced by a rigid attachment of the distal connector 81 with the weight supporting device 40 or by attaching the distal end of the first parallelogram connector to the weight supporting device in a rotatable manner.

FIG. 4 shows a schematical top view of a further user attachment for a gait rehabilitation apparatus behind a user in a centered position. Reference numerals are identical for identical or similar features. The main difference between an embodiment according to FIG. 1 and to FIG. 4 is that the two arms 50 and 60 are attached in FIG. 4 on one side of a weight supporting device 40, whereas for FIG. 1, the arms 50 and 60 are attached on two opposite sides.

It is possible to provide any embodiments of the apparatus without any driven axes. However, the preferred case is to have two driven arms, e.g. at the rotation axis 41 and at the rotation axis 42. But it is also possible to have both drives at one arm, e.g. at axes 41 and 53 so that the guiding arm 60 does not have any drives, or vice versa. It is also possible to have more than two drives, especially a third drive at the axis 54 to orient the harness attachment 55, which could also be realized with a concentric third drive for the arm 81 additionally to the drive at axis 41.

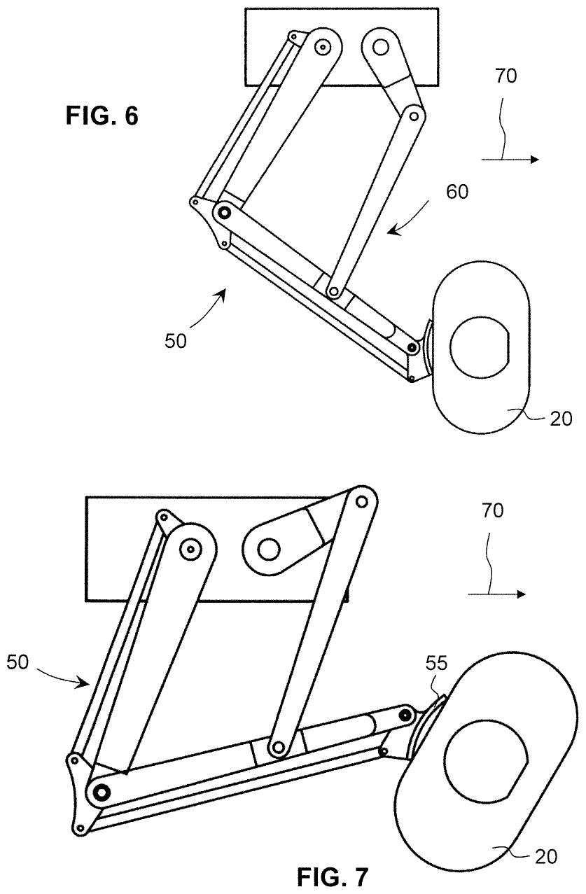

FIG. 5 shows a schematical top view of the gait rehabilitation apparatus of FIG. 4 when the user is in a forward left position in relation to the device and walking into the direction 70. FIG. 6 shows a schematical top view of the gait rehabilitation apparatus of FIG. 4 when the user is in a backward right position in relation to the device, and finally FIG. 7 shows a schematical top view of the gait rehabilitation apparatus of FIG. 4 when the user is in a left transverse and rotated to the right side position in relation to the apparatus.

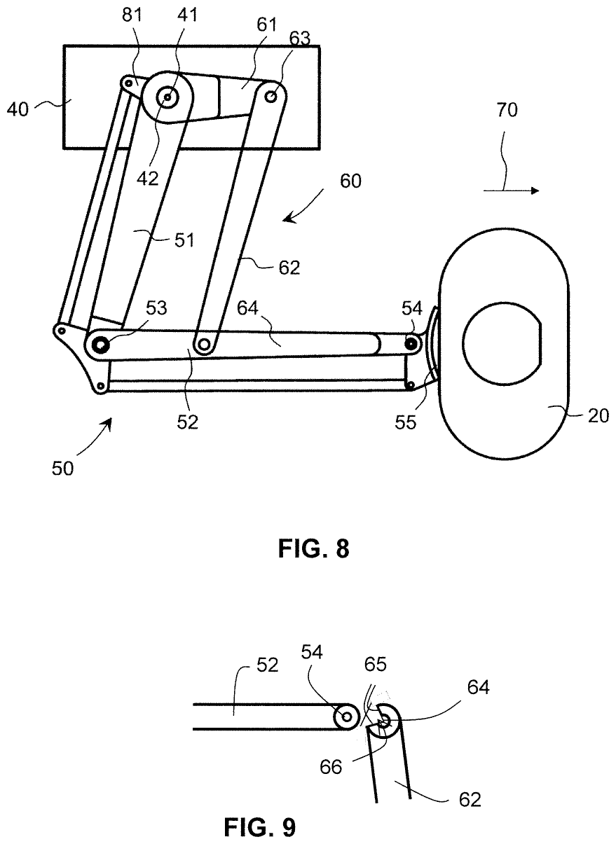

FIG. 8 shows a schematical top view of a further user attachment for a gait rehabilitation apparatus behind a user in a centered position, whereas the first rotation axis 41 of the driven attachment arm 50 as well as the fourth rotation axis 42 of the guiding attachment arm 60 are concentric one to the other.

FIG. 9 shows a detail view of an embodiment of connection between the linkage arms 52 and 62 for a gait rehabilitation apparatus of FIG. 1. It is preferred that the two linkage arms 52 and 62 are only pivoted in the same, especially horizontal plane. Then the pin providing the third rotation axis 54 has to be encompassed in a pivotable manner by the rotatable connection 64. Said rotatable connection 64 comprises a reception to accommodate the pin of axis 54 and an opening 66 with opposing jaw surfaces 65. Then linkage arms 52 and 62 can be pivoted in the drawing plan so that pin 54 can enter the reception 64 via the opening 66 and either one or both jaw surfaces 65 can close together to provide the desired pivoting linkage connection.

1-13. (canceled)

14. A user attachment for an apparatus for gait and balance rehabilitation providing a possibility for a user to receive support during walking in a walking direction, comprising a harness attachable to the body of the user, a driven attachment arm configured to be attached at a weight supporting device and which can be detachably connected with the harness having a harness attachment, wherein the driven attachment arm is connected via a linkage assembly, which comprises a linkage attachment arm, with the harness attachment, and in that the user attachment further comprises a guiding attachment arm configured to be attached at the weight supporting device and which is rotatably connected with the harness attachment or the linkage attachment arm for a rotative connection of the driven attachment arm with the guiding attachment arm wherein the driven attachment arm comprises a support arm and a linkage arm, wherein the support arm is configured to be rotatably attached on a first rotation axis at the weight supporting device at one end and provides a second rotation axis at its other end, wherein the linkage arm is rotatably connected at the second rotation axis with the support arm at one end and provides a third rotation axis at its other end, wherein the harness attachment is rotatably connected at the third rotation axis.

15. The user attachment according to claim 14, wherein the driven attachment arm comprises a force transmitting parallelogram mechanism, wherein the force transmitting parallelogram mechanism is connected between the first rotation axis and the harness attachment for orienting the harness attachment and an attached harness.

16. The user attachment according to claim 15, wherein the force transmitting parallelogram mechanism has a parallelogram arm connected at the first rotation axis, wherein said parallelogram arm is fixed, passively rotating or actively driven.

17. The user attachment according to claim 15, wherein the guiding attachment arm comprises a support arm and a linkage guiding arm, wherein the support arm is configured to be rotatably attached on a fourth rotation axis at the weight supporting device at one end and provides a fifth rotation axis at its other end, wherein the linkage guiding arm is rotatably connected at the fifth rotation axis with the support arm at one end and provides a rotatable connection at its other end being connected with the harness attachment or with the linkage attachment arm for said rotative connection of the driven attachment arm with the guiding attachment arm.

18. The user attachment according to claim 17, wherein none, one or at least two of the first, second, fourth and fifth rotation axis are driven axes.

19. The user attachment according to claim 17, wherein the fourth rotation axis is parallel to the first rotation axis and wherein the two axes are essentially vertical.

20. The user attachment according to claim 17, wherein the first rotation axis of the driven attachment arm as well as the fourth rotation axis of the guiding attachment arm are concentric one to the other.

21. The user attachment according to claim 17, wherein one or two of the first rotation axis and the fourth rotation axis comprise torque sensors.

22. An apparatus for gait and balance rehabilitation comprising a main frame providing a possibility for a user to receive support during walking in a walking direction within this main frame, a harness attachable to the body of the user, a weight supporting device, a driven attachment arm attached at the weight supporting device and which can be detachably connected with the harness having a harness attachment, further comprising a user attachment, wherein the driven attachment arm is connected via a linkage assembly, which comprises a linkage attachment arm, with the harness attachment, and wherein the user attachment further comprises a guiding attachment arm configured to be attached at the weight supporting device and which is rotatably connected with the harness attachment or the linkage attachment arm for a rotative connection of the driven attachment arm with the guiding attachment arm, wherein the driven attachment arm comprises a support arm and a linkage arm, wherein the support arm is configured to be rotatably attached on a first rotation axis at the weight supporting device at one end and provides a second rotation axis at its other end, wherein the linkage arm is rotatably connected at the second rotation axis with the support arm at one end and provides a third rotation axis at its other end, wherein the harness attachment element is rotatably connected at the third rotation axis.

23. The apparatus according to claim 22, wherein the weight supporting device comprises a first weight supporting unit and a second weight supporting unit, wherein the driven attachment arm is attached at the first supporting unit and the guiding attachment arm is attached at the second weight supporting unit, wherein driven attachment arm with the guiding attachment arm are attached at the first weight supporting unit and the second weight supporting unit respectively in a distance one from the other in a transverse direction in view of the intended walking direction of a user.

24. The apparatus according to claim 23, wherein the connection between the guiding attachment arm and the driven attachment arm at either the harness attachment or the linkage attachment arm is detachable.

25. A method for attaching a user to an apparatus for gait and balance rehabilitation comprising a main frame providing a possibility for the user to receive support during walking in a walking direction within this main frame, a harness attachable to the body of the user, a weight supporting device, a driven attachment arm attached at the weight supporting device and which can be detachably connected with the harness having a harness attachment, wherein the driven attachment arm is connected via a linkage assembly, which comprises a linkage attachment arm, with the harness attachment, wherein the user attachment further comprises a guiding attachment arm configured to be attached at the weight supporting device and which is rotatably connected with the harness attachment or the linkage attachment arm for a rotative connection of the driven attachment arm with the guiding attachment arm, comprising the steps of:
pivoting the driven attachment arm and the guiding attachment arm to one side or to two opposing sides towards one or two parking positions in view of the walking direction into vicinity of the side weight supporting device(s),
moving the user from behind the one or two side weight supporting device(s) in view of the walking direction until the user is with his back in front of the harness attachment,
pivoting the driven attachment arm and the guiding attachment arm from the parking positions in a use position for attaching the harness attachment with the harness of the user and, when the parking positions are separated on two sides, connecting the driven attachment arm and the guiding attachment arm at a rotative connection point at the free ends of both the driven attachment arm and the guiding attachment arm.
